(19) United States
(12) Patent Application Publication
(10) Pub. No.: US 2011/0154277 A1
(43) Pub. Date: Jun. 23, 2011

(54) METHOD AND APPARATUS FOR GENERATING SUBSTRATE LAYOUT

(76) Inventors: Christopher J. Ankenbauer, Gilbert, AZ (US); Srinivas S. Moola, Phoenix, AZ (US); Sam Mirza, Chandler, AZ (US)

(21) Appl. No.: 12/642,602

(22) Filed: Dec. 18, 2009

(51) Int. Cl. G06F 17/50

(52) U.S. Cl. 716/103; 716/139; 716/126

(57) ABSTRACT

Embodiments of the invention discuss methods and apparatus for efficiently generating substrate layout for motherboards and packages having high pin-count processors. The method comprises: extracting layout objects associated with a motherboard having a processor; identifying a type for each of the extracted layout objects; reordering the extracted layout objects based on the identified types for each of the extracted layout objects; grouping the layout objects based on the identified types; and generating a motherboard design based on the grouped layout objects.

### FIELD OF THE INVENTION

Embodiments of the invention relate generally to the field of substrate layout design, and more particularly to methods and apparatus for efficiently generating substrate layout for motherboards and packages having high pin-count processors.

### BACKGROUND

As processor pin count increases, motherboard and package design gets complicated. Different computer-aided design (CAD) tools are used to facilitate the design of motherboards and packages. For example, Expedition Enterprise™ by Mentor Graphics™ of Wilsonville, Oreg., is used for auto-routing in substrate layout design for motherboards, and Allegro™ by Cadence Design Systems™ of San Jose, Calif., is used for the physical layout of the motherboard. For optimum motherboard design having processors with high pin count (e.g., 100,000 plus pins), a combination of CAD tools may provide design efficiency and faster time to market the product (motherboard, package, etc.).

Communication between CAD tools of different vendors (e.g., competitors), however, makes it difficult to gain the design efficiency and faster time to market of the product because a CAD tool by one vendor is not designed for communicating with a CAD tool of another competitor vendor. For example, combining CAD tools by taking output from Expedition Enterprise™ and sending that output to Allegro™ as input is error-prone and time consuming because the two CAD tools have incompatible application interfaces.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 illustrates a flow chart for generating a substrate layout for a motherboard or package, according to one embodiment of the invention.

FIG. 2 illustrates a flow chart for generating a processor die symbol, according to one embodiment of the invention.

FIG. 3 illustrates an apparatus/system for executing a method for generating a substrate layout for a motherboard or package and for generating a processor die symbol, according to one embodiment of the invention.

### DETAILED DESCRIPTION

Embodiments of the invention discuss methods and apparatus for efficiently generating substrate layout for motherboards and packages having high pin-count processors. The methods and apparatus allows for combining CAD tools of different vendors, such as Expedition Enterprise™ by Mentor Graphics™ and Allegro™ by Cadence Design Systems™, to achieve a highly efficient substrate layout design flow. Embodiments of the substrate layout design flow are efficient because they improve time to market of the product by several folds by reordering extracted components (discussed below) and by grouping components associated with the motherboard, processor, and packages.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

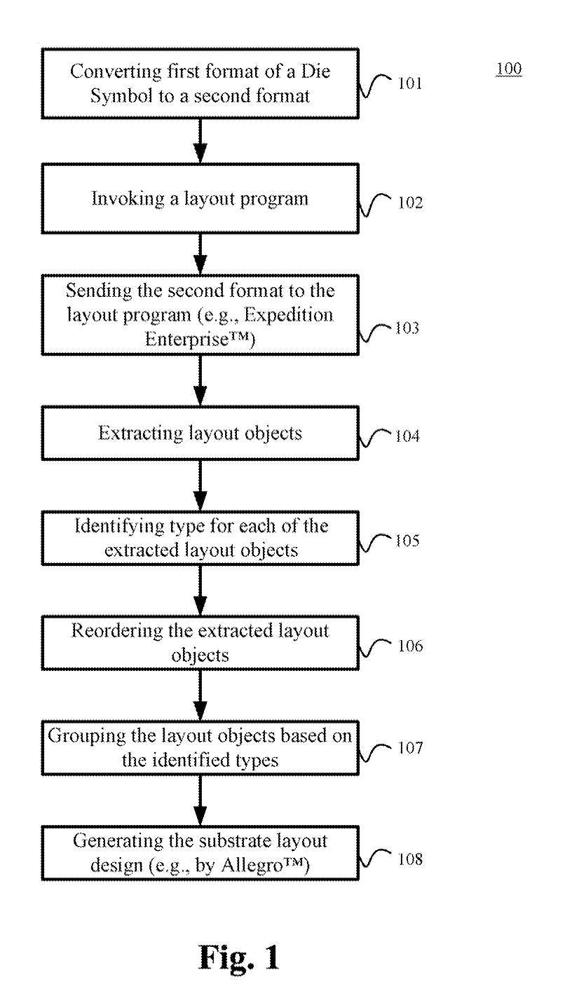

FIG. 1 illustrates a flow chart 100 for generating a substrate layout for a motherboard or package, according to one embodiment of the invention. At block 101, a processor die symbol is converted from a first format to a second format. In one embodiment, the processor die symbol includes die size, die bump locations, die bump sizes, die bump netnames, and die fiducials. In other embodiments, fewer or more die related information is present in the processor die symbol. In one embodiment, the processor die has more than 100,000 pins. In one embodiment, the first format is a native format such as an American Standard Code for Information Interchange (ASCII) format. In other embodiments, the first format is a binary format. In one embodiment, the first format of the die symbol is generated by any Integrated Circuits layout CAD tool. In one embodiment, the second format is one of an HKP™, PDB™, and PCB™ formats from Mentor Graphics™.

At block 102, a layout program is invoked. In one embodiment, the invocation of the layout program involves executing a set of computer-executable instructions to enable the layout program to receive data of the second format from block 101. In one embodiment, the layout program is Expedition Enterprise™ by Mentor Graphics™. In one embodiment, the layout program is Expedition Enterprise™ version EE2007.5 by Mentor Graphics™. At block 103, the second format is input to the layout program.

At block 104, layout objects associated with a motherboard having a processor are extracted by a layout program. In one embodiment, the layout object includes the die symbol in the second format and other components of the motherboard including board layers, nets, padstacks, pins, properties of pins, motherboard outlines, constraint areas, fiducials, FABlayers, vias, multi-vias, traces, teardrops, and shapes and voids. In one embodiment, the layout program is Expedition Enterprise™ of Mentor Graphics™ version EE2007.5.

At block 105, types for each of the extracted layout objects are identified. In one embodiment, the type of layout object extracted by the layout program is either of package type or board type.

In one embodiment, the package type includes layout objects associated with packages for processors. In one embodiment, the package type is further classified as core and coreless types signifying motherboard and/or package layer stack-up. In one embodiment, the package type affects the layer thicknesses and layer naming conventions. For example, substrates with core as package type have a thick center layer while substrates with coreless as package type do not have a thick center layer. The thickness of the center layer varies with package technology.

In one embodiment, the board type includes layout objects directly associated with the motherboard (e.g., motherboard layers, dielectric constant, traces and their properties (width, thickness, material), boundary of the motherboard layers, etc.).

At block 106, the extracted layout objects from block 105 are reordered. In one embodiment, the reordering is based on the following order: nets, padstacks, components such as pins and their properties, motherboard and package outlines, constraint areas, user layers, fiducials, FABlayers, vias, multi-vias, traces, teardrops, and shapes and voids. The reordering of the extracted layout objects allows for efficient grouping of types of the extracted layout objects. In one embodiment, re-ordering of objects is the only way to create a layout object. For example, a layer needs to be created before a trace on that layer can be created. In one embodiment, simple objects (e.g., nets) are created first to improve computation speed of object creation. For example, computation speed of object creation in Allegro™ of Cadence Design Systems™ is improved by 50% by re-ordering extracted layout objects compared to the computation speed of object creation in Allegro™ without reordering of the extracted layout objects.

At block 107, layout objects are grouped based on the identified types. In one embodiment, components associated with the motherboard, such as all nets, are grouped as one stack. In one embodiment, all pins and their properties are grouped one stack called components. In one embodiment, pin properties include nature of pins (power pins, signal pins, DC pins, ground pins, etc.) and notes/commentary inserted by a layout designer for a pin.

In one embodiment, outlines, constraint areas, user layers, fiducials, and FABlayers are grouped as one stack. The grouping allows for efficient conversion of extracted layout objects to a second layout program. The grouping also eliminates the error prone process of converting extracted layout objects, of various types, from a first layout program to the second layout program. In one embodiment, SKILL™ programming language of Cadence Design Systems™ is used for grouping the layout objects for the second program. In one embodiment, the first layout program is Expedition Enterprise™ (e.g., version EE2007.5) of Mentor Graphics™ and the second layout program is Allegro™ of Cadence Design Systems™

At block 108, the motherboard and/or package design is generated based on the grouped layout objects. In one embodiment, the second layout program is invoked to generate the motherboard design. In one embodiment, the invocation of the second layout program involves executing a set of computer-executable instructions to enable the second layout program to receive the grouped data from block 107. In one embodiment, the second layout program is Allegro™ of Cadence Design Systems™.

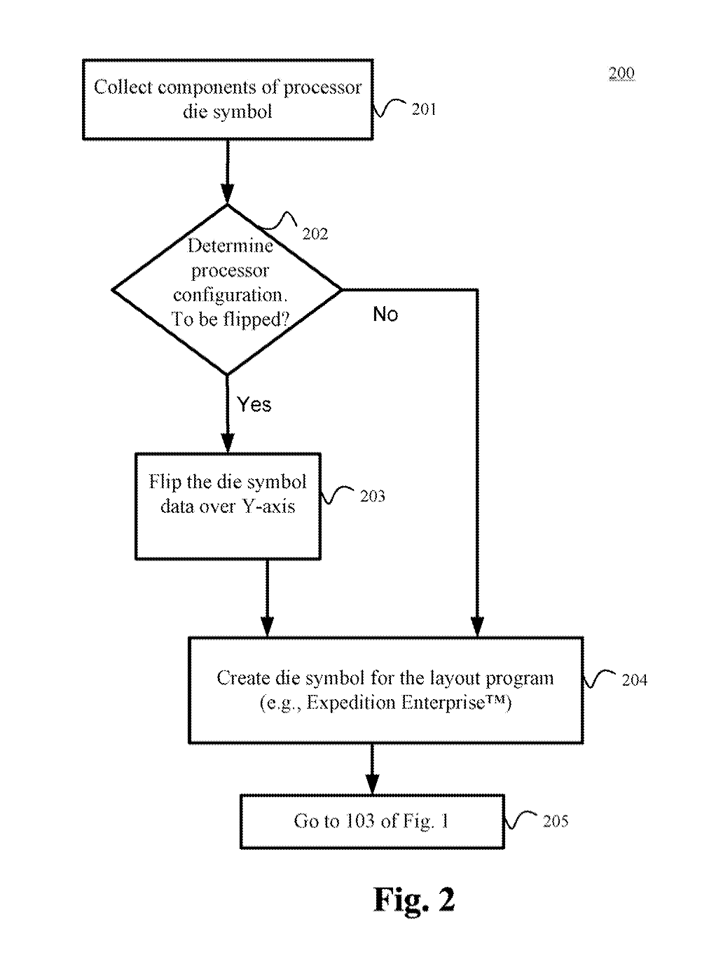

FIG. 2 illustrates a flow chart 200 for generating a processor die symbol, according to one embodiment of the invention. At block 201, components of the processor die symbol are collected. In one embodiment, the processor die symbol includes die size, die bump locations, die bump sizes, die bump netnames, and die fiducials. In one embodiment, the collected components are in ASCII format.

At block 202, a determination is made whether the processor is configured to be flipped in a processor package. If the processor is configured to be flipped in the processor package, then the processor die symbol data is flipped. A processor die symbol data is flipped if the processor bumps are on the top layer of the processor die. In one embodiment, the processor die symbol is flipped by multiplying the X-coordinate of the die symbol data with negative one. If the processor is not configured to be flipped in the processor package, then the processor die symbol data is not flipped.

In one embodiment, the first layout program (discussed above in conjunction with FIG. 1) is not configured to flip the processor die symbol data. In such an embodiment, at block 203, the processor die symbol data is flipped over the Y-axis by multiplying the X-coordinates of the die symbol data with negative one.

At block 204, the processor die symbol data is converted from ASCII format to a first format for a layout program. In one embodiment, the first format is one of an HKP™, PDB™, and PCB™ formats from Mentor Graphics™. In one embodiment, the layout program is Expedition Enterprise™ (e.g., version EE2007.5) by Mentor Graphics™. At block 205, the process discussed in FIG. 1 is continued from block 103.

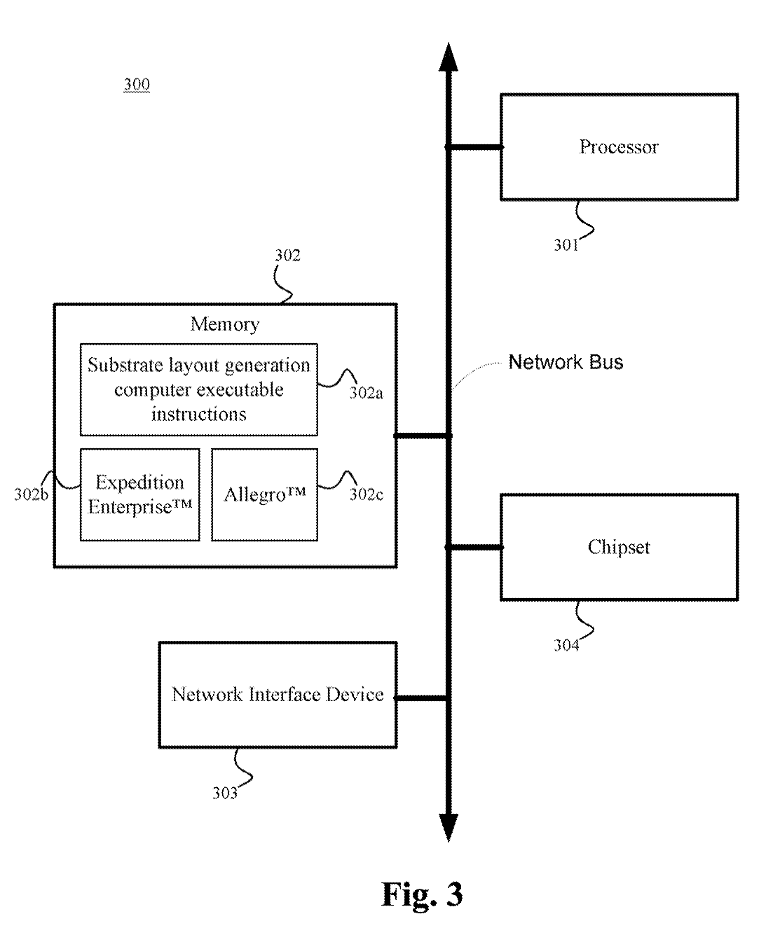

FIG. 3 illustrates an apparatus/system 300 for executing a method for generating a substrate layout for a motherboard and/or package, and for generating a processor die symbol, according to one embodiment of the invention. In one embodiment, the apparatus comprises a processor 301 coupled with a memory 302 via a network bus. In one embodiment, the network bus has other devices coupled with it including a network interface device 303 and a chipset 304. In one embodiment, the memory 302 includes instructions to execute the method discussed in FIGS. 1-2 and the method discussed herein. In one embodiment, the processor 301 includes logic to execute the instructions in the memory 302. While FIG. 3 shows a processor 301 as a separate entity than the memory 302 for storing the instructions for generating a substrate layout for a motherboard and/or package, and for generating a processor die symbol, in one embodiment these instructions can be stored within the cache (not shown) of the processor 301.

In one embodiment, the memory 302 is a machine-readable medium for storing the computer-executable instructions. In one embodiment, the computer-executable instructions include instructions 302a for substrate layout generation used for motherboard design, package design, die symbol, etc., as discussed in reference to FIG. 1 and FIG. 2. In one embodiment, the computer-executable instructions also include executable instructions of Expedition Enterprise™ (e.g., version EE2007.5) 302b and Allegro™ 302c. The computer-executable instructions when executed cause the processor 301 to perform the process discussed in FIG. 1 and FIG. 2.

The machine-readable medium may include, but is not limited to, memory 302, flash memory, optical disks, CD-ROMs, DVD ROMs, RAMs, EPROMs, EEPROMs, magnetic or optical cards, or other type of machine-readable media suitable for storing electronic or computer-executable instructions. For example, embodiments of the invention may be downloaded as a computer program (e.g., BIOS) which may be transferred from a remote computer (e.g., a server) to a requesting computer (e.g., a client) by way of data signals via a communication link (e.g., a modem or network connection).

While the invention has been described in conjunction with specific embodiments thereof, many alternatives, modifications and variations will be apparent to those of ordinary skill in the art in light of the foregoing description. Embodiments of the invention are intended to embrace all such alternatives, modifications, and variations as to fall within the broad scope of the appended claims.

We claim:

1. A method comprising:
extracting layout objects associated with a motherboard having a processor;
identifying a type for each of the extracted layout objects;
reordering the extracted layout objects based on identified types for each of the extracted layout objects;
grouping the layout objects based on the identified types; and
generating a motherboard design based on the grouped layout objects.

2. The method of claim 1, further comprises:
converting a first format representing a die symbol of the processor to a second format;
invoking Expedition Enterprise™; and
sending the second format to the invoked Expedition Enterprise™.

3. The method of claim 2, wherein the layout objects includes the die symbol and components of the motherboard including board layers, nets, padstacks, pins, vias, traces, and teardrops.

4. The method of claim 1, wherein the reordering the extracted layout objects comprises ordering the extracted layout objects in an order consisting of: nets, padstacks, pins, vias, traces, and teardrops.

5. The method of claim 2, wherein the second format includes a PCB™ format.

6. The method of claim 1, wherein extracting the layout objects associated with the motherboard comprises:
invoking Expedition Enterprise™; and
sending a layout of the motherboard to the invoked Expedition Enterprise™.

7. The method of claim 1, wherein identifying the type for each of the extracted layout objects comprises:
determining a package and a board type; and
determining a core and a coreless type of the package.

8. The method of claim 1, wherein generating the motherboard design comprises:
invoking Allegro™; and
sending the grouped layout objects to the invoked Allegro™.

9. A computer-readable storage medium having computer executable instructions stored thereon, the computer executable instructions when executed cause a computer to perform a method, the method comprising:
extracting layout objects associated with a motherboard having a processor;
identifying a type for each of the extracted layout objects;
reordering the extracted layout objects based on identified types for each of the extracted layout objects;
grouping the layout objects based on the identified types; and
generating a motherboard design based on the grouped layout objects.

10. The computer-readable storage medium of claim 9, having further computer executable instructions stored thereon, the further computer executable instructions when executed cause the computer to further perform a method, the comprising:
converting a first format representing a die symbol of the processor to a second format;
invoking Expedition Enterprise™; and
sending the second format to the invoked Expedition Enterprise™.

11. The computer-readable storage medium of claim 9, wherein the layout objects includes the die symbol and components of the motherboard including board layers, nets, padstacks, pins, vias, traces, and teardrops, and wherein the reordering the extracted layout objects comprises ordering the extracted layout objects in an order consisting of: nets, padstacks, pins, vias, traces, and teardrops.

12. The computer-readable storage medium of claim 10, wherein the second format includes a PCB™ format.

13. The computer-readable storage medium of claim 10, wherein extracting the layout objects associated with the motherboard comprises:
invoking a Expedition Enterprise™; and
sending a layout of the motherboard to the invoked Expedition Enterprise™.

14. The computer-readable storage medium of claim 10, wherein generating the motherboard design comprises:
invoking Allegro™; and
sending the grouped layout objects to the invoked Allegro™.

15. A system comprising:
a network bus;
a memory coupled with the network bus, the memory including instructions; and
a processor coupled with the memory via the network bus, the processor having logic to execute the instructions to perform a method comprising:
extracting layout objects associated with a motherboard having a processor;
identifying a type for each of the extracted layout objects;
reordering the extracted layout objects based on identified types for each of the extracted layout objects;
grouping the layout objects based on the identified types; and
generating a motherboard design based on the grouped layout objects.

16. The system of claim 15, wherein the method further comprising:
converting a first format representing a die symbol of the processor of the motherboard to a second format;
invoking Expedition Enterprise™; and
sending the second format to the invoked Expedition Enterprise™.

17. The system of claim 16, wherein the second format includes a PCB™ format.

18. The system of claim 15, wherein the layout objects includes the die symbol and components of the motherboard including board layers, nets, padstacks, pins, vias, traces, and teardrops.

19. The system of claim 15, wherein the reordering the extracted layout objects comprises ordering the extracted layout objects in an order consisting of: nets, padstacks, pins, vias, traces, and teardrops.

20. The system of claim 15, wherein extracting the layout objects associated with the motherboard comprises:
invoking Expedition Enterprise™; and
sending a layout of the motherboard to the invoked Expedition Enterprise™, and wherein generating the motherboard design comprises:
invoking Allegro™; and
sending the grouped layout objects to the invoked Allegro™.
